(19) United States
(12) Patent Application Publication
(10) Pub. No.: US 2014/0098708 A1
(43) Pub. Date: Apr. 10, 2014

(54) METHOD AND TOOLING FOR CONFIGURING A NETWORK OF UNATTENDED GROUND WIRELESS SENSORS

(71) Applicant: THALES, Neuilly Sur Seine (FR)

(72) Inventors: Jeremie LEGUAY, Colombes (FR); Vincent GAY, Colombes (FR); Mario LOPEZ-RAMOS, Colombes (FR); Paolo MEDAGLIANI, Cingia De'botti (cr) (IT); GianLuigi FERRARI, Parma (IT)

(73) Assignee: THALES, Neuilly Sur Seine (FR)

(21) Appl. No.: 14/100,746

(22) Filed: Dec. 9, 2013

Related U.S. Application Data
(63) Continuation of application No. 13/097,125, filed on Apr. 29, 2011.

(30) Foreign Application Priority Data
Apr. 30, 2010 (FR) 10 01869

(51) Int. Cl. H04W 16/18; H04W 88/18

(52) U.S. Cl. CPC H04W 16/18; H04W 88/18
USPC 370/254

(57) ABSTRACT

The method for configuring a network of deposited wireless sensors. In certain aspects, these methods include defining performance criteria forming constraints, with associated threshold values, and at least one performance criterion to be optimized, for at least one zone to be equipped with nodes, each performance criterion being defined by a model; defining for said or each zone; the allocation to said or each zone to be equipped, a number of nodes; applying an optimization process per zone on said or each zone; increasing the number of nodes or modifying the performance criteria defined in said or each zone where the performance criteria are not met and reproducing in these zones the optimization process per zone with the new number of nodes or the new performance criteria, and applying the configuration determined at each node in said or each zone.

### CROSS-REFERENCE TO RELATED APPLICATIONS

This is a continuation application of U.S. patent application Ser. No. 13/097,125 filed on Apr. 29, 2011, which claims priority to French Patent Application No. 10 01869 filed on Apr. 30, 2010. The above-identified patent applications are incorporated herein, by reference, in their entireties.

### FIELD OF THE INVENTION

This invention relates to a method for configuring a wireless network of unattended ground sensors, of the type consisting of interconnected nodes each including a sensing module named a sensor, an own power supply source, computing means, communication means, means for saving an operating configuration and means for managing its operation according to this configuration stored in memory.

### BACKGROUND OF THE INVENTION

Networks of unattended ground wireless sensors designated as UGS networks (Unattended Ground Sensor networks), are intended to detect an intrusion in a zone to be monitored and inform about this intrusion after detection. They consist of stand-alone devices forming nodes which have a stand-alone power supply, radio communications capabilities, observation capabilities (via the use of transducers or more complex modules), and (more or less high) computing capacities.

These nodes are set in a network most often by using self-organization functions in the fashion of so-called ad hoc networks. In this case, since communication is a priori only possible between the nodes within radio range, a routing protocol (for example Direct Broadcasting) then ensures the relay of data packets in order to ensure connectivity from one end to the other when this is allowed by the topology of the network.

In UGS networks, the nodes are dropped (for example jettisoned by an airplane, deposited by an operator on foot) in a localization or a given geographical zone in order to accomplish a monitoring function. The dropped sensors monitor collaboratively (or not) the activities of interest (for example, intrusions) in the zone where they operate, and then return alerts to so-called gateway nodes so that they are transmitted to other portions of the monitoring system (for example a control and monitoring centre, other sensors, actuators).

UGS networks have military applications within the scope of monitoring missions, but also civil applications for monitoring critical infrastructures (for example classified factories, bridges) or for environmental monitoring (for example seismic risk, agriculture, ecology).

UGS nodes generally have power supply constraints. In the majority of the cases, they operate on a battery. In order to save on the battery, they are equipped with an intermittent standby mechanism for the measurement sensors and the transmission means.

The operator should then upon deployment or during operation, decide on a certain number of parameters of the system, i.e.:
The location of each node, which has an influence on the performance in terms of detection.
The duration during which and the number of times a sensor observes a phenomenon which has an influence on the power consumption of the sensor and more globally, a global impact on the lifetime of the system and on the degradation over time of its detection performances.
The duration during which and the number of times a sensor activates its wireless communication interface for receiving or sending information has an impact on the lifetime of the sensor and on the network performances, notably in terms of transmission delay.

The selection of the parameters of the system strongly influences its performances.

For example the following performance indicators are defined:
P_{md} (Probability of miss-detection): this is the probability that the network does not detect an event (for example the arrival of a target or a phenomenon) while being aware that it has occurred. This probability for example depends on the level of vigilance of the nodes (for example the sampling frequency of the seismic signal), on their geographic position, on the capability of the sensors of collaboratively correlating their observations.
Far (False alarm rate): this is the number of times per unit time that the system sends back alarms relating to uninteresting events. For example, if the system sends back an alarm stating that a pedestrian has just entered the zone, when this is simply wild game. Classification techniques (which may be distributed) are generally used or <<disambiguating>> the alarms.
D (Delays for transmitting the alert): this is the delay for transmitting the alert to the gateway node. This delay generally depends on the MAC (Medium Access Control) protocol and on the routing used as well as on the associated parameters.
L (Lifetime of the system): this indicator gives the time during which the system is considered as operational. It may be computed in different ways, for example: the time until at least one sensor lacks power for operating.

In UGS networks, the operating unit in charge of its configuration and of its deployment should therefore decide on the system parameters corresponding to a given operating point (for example Pmd<10%, 10 deployed nodes). This problem is difficult and requires good understanding of the compromises encountered by the system, the latter being strongly related to the selected protocols, to the behaviors of the hardware modules, etc.

In T. He, S. Krishnamurthy, L. Luo, T. Yan, L. Gu, R. Stoleru, G. Zhou, Q. Cao, P. Vicaire, J. A. Stankovic, T. F. Abdelzaher, J. Hui, and B. Krogh, “Vigilnet: An integrated sensor network system for energy-efficient surveillance,” ACM Trans. Sen. Netw., Vol. 2, no. 1, pp. 1-38, February 2006, the authors present the design and the application of a monitoring system, designated as VigilNet, based on a UGS network. The authors show the compromises which such a system encounters within the framework of the use of duty cycles. In an extension of the preceding investigations, J. Jeong, Y. Gu, T. He, and D. Du, “VISA: Virtual Scanning Algorithm for Dynamic Protection of Road Networks,” in Proc. of 28th IEEE Conference on Computer Communications (INFOCOM 09), Rio de Janeiro, Brazil, April 2009, proposes the detection of the passing of vehicles along a road. Each sensor periodically performs detection. The proposed strategy consists of defining a scheduling of these detection periods as a periodic scanning over the whole length of the monitored road segment.

In L. Lazos, R. Poovendran, and J. A. Ritcey, “Analytic evaluation of target detection in heterogeneous wireless sensor networks,” ACM Trans. Sensor Networks, Vol. 5, no. 2, pp. 1-38, March 2009 noted as [Lazos09], the authors consider a UGS network wherein: (1) the sensors permanently observe the appearance of the target in their coverage zone, (2) the targets have an arbitrary incidence but a rectilinear trajectory. The authors propose the use of analytical geometry with integration in order to calculate the detection probability of these targets by at least one sensor within the framework of a deterministic (i.e., knowing the positions of the sensors) or stochastic (i.e., only knowing the number of sensors) deployment. In the stochastic case, an exact mathematical expectation is found for the non-detection probability. In the deterministic case, the authors give a formulation of the lower and upper limits which does not take into account the existence of cycles for activating/putting on stand-by the measurement and/or communication modules.

In P. Medagliani, J. Leguay, V. Gay, M. Lopez Ramos, G. Ferrari. “Engineering Energy-Efficient Target Detection Applications in Wireless Sensor Networks.” Conference IEEE Percom 2010 (Mannheim, Germany, March 2010) designated in the following by [Meda09], the authors consider the case of stochastic deployment and extend the work of L. Lazos, R. Poovendran, and J. A. Ritcey, “Analytic evaluation of target detection in heterogeneous wireless sensor networks,” ACM Trans. Sensor Networks, Vol. 5, no. 2, pp. 1-38, March 2009, by integrating the fact that the sensors may perform their observation periodically (and not permanently) in order to reduce their power consumption. The authors also propose modeling of the delay for transmitting the alerts by considering the case of the X-MAC protocol, which also uses periodic activations/deactivations of the communication interface in order to reduce power consumption. Finally, this work comprises a model of the power consumption of a network of sensors, giving the possibility of more globally inferring the lifetime of the network from the remaining power and from the activity/vigilance level of the UGS network. The authors show the use of this analytical framework with multi-objective optimization techniques. This allows the operator to view the global performances of the system depending on its constraints (for example lifetime, detection performance). The operator may thereby perceive the compromises with which he/she has to cope and decide on the configuration which he/she desires to adopt. The proposed tool is used for a fixed number of nodes, randomly deployed.

In J. J. Sylvester, “On a funicular solution of Buffon's “problem of the needle” in its most general form,” Acta Mathematica, Vol. 14, no. 1, pp. 185-205, 1890., Sylvester tackles the so-called needle geometrical problem: a plane is striated with parallel lines spaced out by a distance. A needle of length l is randomly thrown. What is the probability that the needle will cut one of these lines? the resolution of this problem by Sylvester gives the possibility of analytically refining the upper limit given by L. Lazos, R. Poovendran, and J. A. Ritcey, “Analytic evaluation of target detection in heterogeneous wireless sensor networks,” ACM Trans. Sensor Networks, Vol. 5, no. 2, pp. 1-38, March 2009, for the non-detection probability in the deterministic case.

The analytical framework proposed in [Meda09] allows modeling of an UGS system within the framework of stochastic deployment. From an operational point of view, the operators may handle this model by using optimization tools for observing the space of optimum configurations according to objectives and constraints defined by the operator himself/herself. With this, the underlying compromises of the system's operation may be understood. The constraints and objectives may for example be the maximization of the detection performances subject to constraints on the delays for transmitting the alerts.

This model and the tooling do not provide results specific to a given deployment of sensors (a more interesting case for UGS network operators). They provide average results (in the mathematical sense) which have to be used as an indication by the operators in order to decide on the parameterization of their network. Moreover, they do not provide assistance to the operator for placing the nodes in a particular geographical zone. Finally, there is no tool with which the operator may be informed on the minimum number of nodes required for meeting the constraints and operational objectives to be fulfilled.

The methods of the state of the art do not provide assistance to the UGS network operators for placing the nodes and configuring the parameters of the system within the scope of a particular operational background of the camp/zone monitoring type.

Moreover, the methods of the state of the art do not allow determination of the minimum number of nodes required on a set of distinct zones to be monitored, each having constraints and particular operational objectives.

### SUMMARY OF THE INVENTION

The object of the invention is to propose a method and a device for configuring a network of deposited wireless sensors in one or more geographical zones which allow determination of the number and position of the sensors in order to attain performances meeting targeted performance criteria.

For this purpose, the object of the invention is a method for configuring a network of deposited wireless sensors of the aforementioned type, characterized in that it includes the following steps:
1. Defining performance criteria forming constraints, with associated threshold values, and at least one performance criterion to be optimized, for at least one zone to be equipped with nodes, each performance criterion being defined by a model
2. Defining for said or each zone:
   a. Characteristics of the zone
   b. Characteristics of the sensors in the zone
3. Allocating a number of nodes to said or each zone to be equipped.
4. Applying an optimization process per zone on said or each zone, the zone optimization process applying the following steps:
   a. Determining the position of the nodes in the zone if there exists a predetermined optimization criterion to be met;
   b. Determining an operating point if it exists, characterizing the behavior of the network of sensors in the zone, and
   c. Determining the configuration of the network of sensors in the zone if it exists, defining the parameters for configuring the network of sensors, and
   d. Determining the possible need of using more nodes or revising the performance criteria defined in step 1,
5. Increasing the number of nodes or modifying the performance criteria defined in said or each zone where the performance criteria are not met and reproducing in these zones the zone optimization process with the new number of nodes of the new performance criteria, and
6. Applying the configuration determined at each node in said or each zone.

According to particular embodiments, the method includes one or more of the following features:
the step for defining performance criteria to be optimized comprises the definition of a threshold value to be attained for at least one performance criterion to be optimized, and the optimization process per zone includes a step for incrementing the number of nodes for equipping the zone, if at least one performance criterion to be optimized is not met, in order to determine the minimum number of nodes required for meeting the performance criteria, and reproduction of steps 4a to 4c with the new incremented number of nodes;
the step for defining performance criteria to be optimized comprises the definition of a threshold value to be attained for at least one performance criterion to be optimized, and the optimization process per zone includes a step for decrementing the number of nodes for equipping the zone, if all the performance criteria to be optimized are met, in order to determine the minimum number of nodes required for meeting the performance criteria, and reproduction of the steps 4a to 4c with the new decremented number of nodes;
the step for defining the characteristics of the zone comprises the definition of a minimum value for the size of the zone, and the optimization process per zone includes successive steps for incrementing the size of the zone and for reproducing steps 4a to 4c with the new size of the zone, until there is no operating point meeting the performance criteria forming constraints;
the predetermined optimization criterion, for determining the position of nodes, is to minimize a probability of non-detection by the network with the assumption of permanent activation of the sensor of each node;
the step for allocating nodes in at least one zone comprises the setting of imposed positions for at least one node in the zone and the step for determining the position of the nodes takes into account the imposed positions for at least said node; and
the method includes analytical modeling of the probability of non-detection of a target applying the known positions of the sensor.

The object of the invention is a device for configuring a network of deposited wireless sensors of the aforementioned type, including means for applying the steps of the method as defined above.

The object of the invention is also a computer program including specific instructions applying the method as defined above, when used on a computer.

### BRIEF DESCRIPTION OF THE DRAWINGS

The invention will be better understood upon reading the description which follows, only given as an example and made with reference to the drawings wherein:

FIG. 1 is a diagram illustrating a network of deposited wireless sensors or unattended ground wireless sensor network protecting a camp;

FIG. 2 is a schematic view of the device applying the configuration method according to the invention;

FIG. 3 is a flowchart of the general method according to the invention for an exemplary application on 3 geographic zones;

FIG. 4 is a diagram of an example of the successive results of the general method according to the invention;

FIG. 5 is a flowchart of a sub-procedure applied in the method according to the invention illustrated in FIG. 3;

FIG. 6 is a graph showing a space of solutions meeting the performance criteria within the scope of the application of a sub-procedure applied in the method according to the invention;

FIG. 7 is a diagram of an example of the successive results of the sub-procedure as described with reference to FIG. 5;

FIG. 8 is a schematic view of the coverage range of a node of the network of sensors;

FIG. 9 is a diagram illustrating the sleep cycles of a module of a node;

FIGS. 10, 11 and 12 are schematic views of the coverage ranges of two nodes illustrating different calculations applied in the method; and

FIG. 13 is a view illustrating the deployment of sensors in a zone.

### DETAILED DESCRIPTION OF THE INVENTION

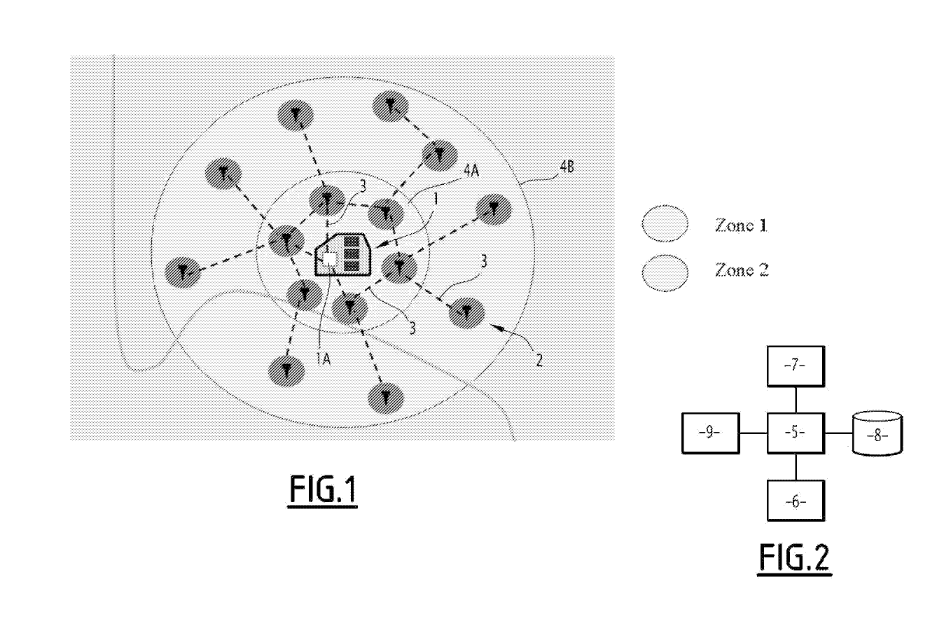

A top view of a site which has to be protected is illustrated In FIG. 1. At the centre is found an encampment 1 equipped with a monitoring terminal 1A to which possible alarms from detection of intrusions are sent back by a network of deposited or unattended wireless sensors designated as UGS networks in the following.

This network includes a set of nodes 2 interconnected by wireless connections 3 directly or indirectly connecting the nodes to the monitoring terminal 1A. The indirect connections are made as known per se through other intermediate nodes.

The nodes 2 each correspond to a sensor of the network. They each include for example a seismic sensor with which vibration of the ground may be detected in its field of action when a person or a vehicle penetrates therein. Each of the nodes in addition to its own sensor has an own power supply source, its means for communicating with the other nodes 2 and/or the terminal 1A, its own computing means as well as means for saving an operating configuration and for managing its operation according to this configuration stored in memory.

In the example of FIG. 1, the nodes 2 are distributed in two concentric zones 4A and 4B surrounding the encampment 1. These zones, currently designated as glacis, form zones for detecting a possible intrusion by different nodes bearing sensors. In each of these zones, the UGS network is configured in a different way in order to attain different targeted performances.

The method is applied in a portable device used by the operator and notably including, as illustrated in FIG. 2:
an information processing unit 5,
an information input keyboard 6,
a display screen 7 for making information available to the operator
a database 8 notably containing:
   the characteristics of the nodes which may be used and their behavior model;
   a model for each performance criterion depending on the number of deployed nodes; and
   the method applied according to the invention, and
a temporary connection interface 9 at each node for saving its configuration in the latter.

As known per se, notably from [Meda09], several performance criteria, noted as CP, are defined for characterizing the operation of a UGS network in a given zone. For example, are considered as CPs:
The probability of non-detection (P_{md})
The delay for transmitting the alerts (D)
The lifetime of the system (L)

For each type of CP, the device applying the method includes a model in an empirical form (for example an abacus) or in analytical form (a mathematical expression). Each model takes into account the configurable parameters of the system subsequently described in a section (for example: placement of the nodes, proportion of the time when the sensor module is active βₛₑₙₛ, proportion of the time during which the radio module is active β_{comm}) An example for each of the CPs mentioned above, is given in the subsequent description.

Within the scope of deployment of a UGS network for monitoring purposes, two categories of CPs are defined:
The CPs forming constraints (CPCs): these are CPs for which the operator defines a set of “threshold” values, noted as CPC*s, which constrain the operating point to be attained. For example, the UGS network should operate so that the P_{md} is less than (P_{md})*=10%, in other words such that the probability of missing a target crossing the zone is less than 10%.
The CPs to be optimized (CPO): these are CPs for which the operator wishes to know the optimum value subject to given CPC*s. The CPO type(s) implicitly indicate(s) the direction(s) along which an optimization technique, P_{OPT}, defined later on in the description, has to operate. For example:
   CPO={P_{md}}: Minimization of the probability of non-detection P_{md}
   CPO={L}: Maximization of the lifetime of the system L
   CPO={D}: Minimization of the delay for transmitting the alerts D

For example, the operator wishes to maximize L considering constraints on P_{md} and D, one has: CPO={L}, CPC={Pmd, D}, with CPC*={P_{md}*=10% and D*=100 ms}. In this case, the optimization technique for example indicates that the maximum value of L is 30 days.

During the application of the method, the operator initially specifies among the whole of the CPs at least one CPC, associated with a CPC* value, and at least one CPO. A CP type cannot be both associated with a CPC and a CPO.

An n-uplet of values corresponding to different CPs, which characterizes the operation of the UGS network for a given proportioning of the system parameters of the UGS network, is called an operating point noted as PF. For example, for the parameterization (βₛₑₙₛ=4%, β_{comm}=13%) and a certain placement of nodes, the operating point PF is thus defined: P_{md}=17% , D=113 ms, L=27 days.

The object of the method is to assist an operator in charge of the deployment or maintenance of the UGS network by assisting him/her with making the system configuration selections considering:
Operational constraints. For example:
   “Threshold” values on the CPCs. For example, the operating point on a zone should satisfy the condition that the probability of non-detection of a target is less than 10% (P_{md}*=10%).
   Positioning certain nodes by the knowledge which the operator has about the site.
(optional) “Objective” values on the CPOs. For example, the best attainable lifetime is of at least 100 days.

The method may be used for configuring k sub-systems deployed in a set of zones to be monitored, noted as Z={Z₁, Z₂, . . . , Zₖ}, each zone having specific operational constraints.

In order to determine the optimum configuration of a zone, the method provides two modes which the operator may select and which correspond to two different approaches:
MODE1: the operator wishes to operate the sub-system in a way which as a priority meets the constraints on certain CPs (CPCs), regardless of the optimum value obtained on other CPs (CPOs).

In this case, no objective is set on the CP to be optimized. The purpose is to determine if it exists, the optimum PF for a given number of nodes, i.e. the PF which observes the constraints and gives the best value which may be expected for CPO, regardless of the latter.

For example, if CPO={L}, CPC={P_{md}, D}, with CPC*={P_{md}*=10% and D*=100 ms}, the method determines that the best operating point with 5 nodes, considering L is such that: L=30 days, P_{md}=10%, D=100 ms.
MODE2: the operator wishes to operate the UGS network in a way which meets the constraints on certain CPs on the one hand and such that the optimum value on certain CPs is beyond an objective value, noted as CPO_{obj}, on the other hand.

An objective is set on the CP to be optimized. The purpose is to determine the minimum number of nodes to be used such that CPO_{obj} is attained and the constraints are observed for the optimum PF.

For example, if CPO={L} with CPO_{obj}=L_{obj}=10 days, and CPC={Pmd, D}, with CPC*={P_{md}*=10% and D*=100 ms}, the method indicates that the minimum required number of nodes so that the sub-system lasts for at least 10 days is of 3 nodes.

By acting on the number of nodes, their possible positions, on the constraints (for example CPC*, size of the zone) and defined objectives (for example CPO_{obj}), the operator is invited to perform the global method, noted as PROC_GLOBAL_{Z}, iteratively until operating points are found which are satisfactory for the whole of the zones within the limit of the total number of nodes at his/her disposal.

The global method for assisting with the deployment is noted as PROC_GLOBAL_{Z}. This method is applied on a set of zones Z, the characteristics and operational constraints of which vary.

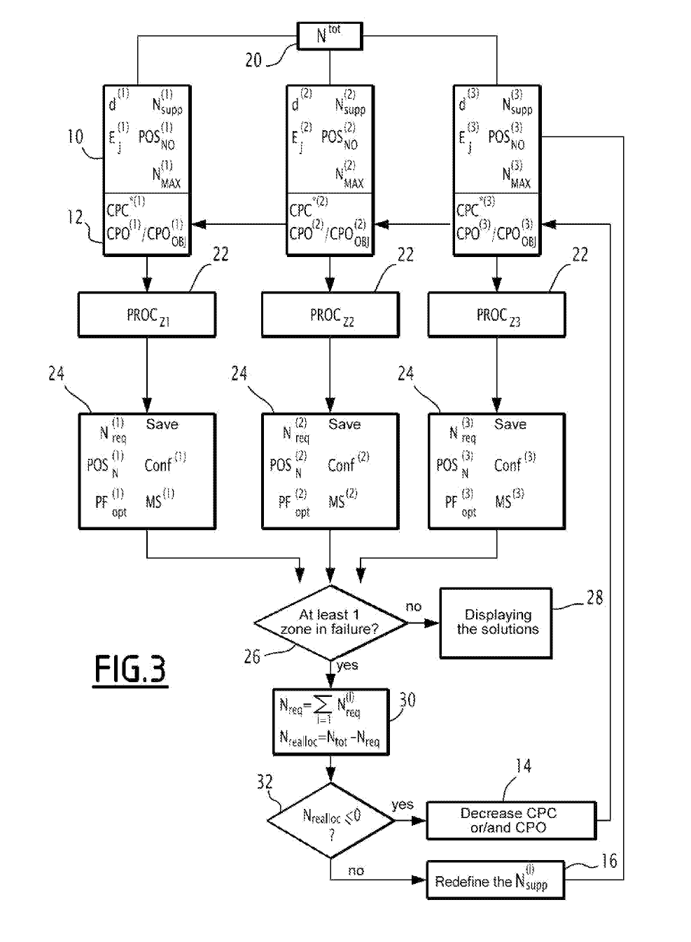

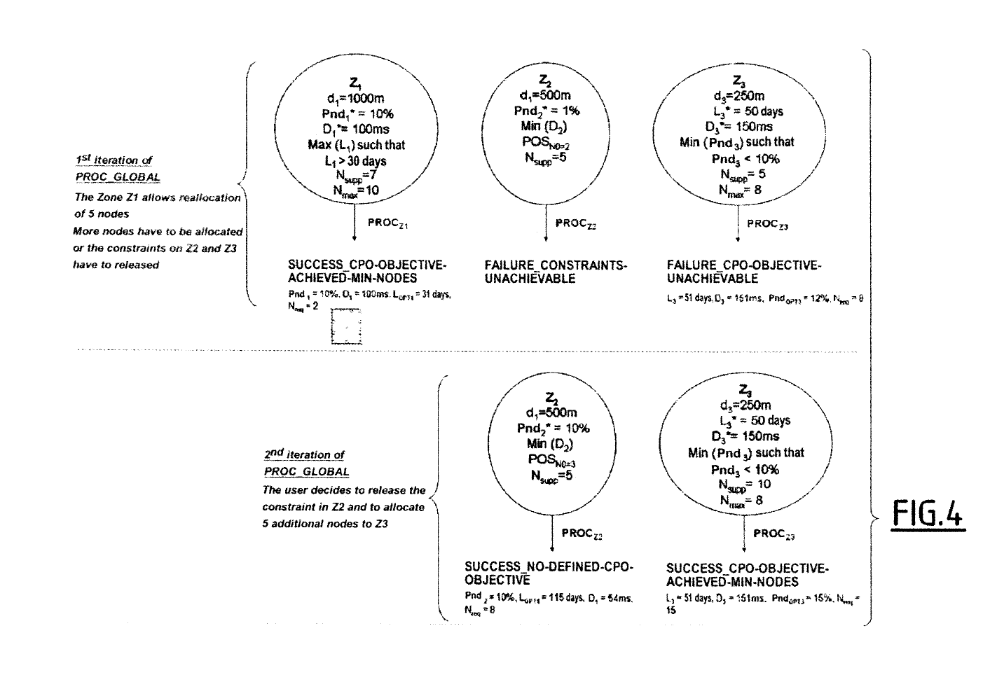

FIG. 3 shows the operating principle of the global method in the case when 3 zones are applied.

According to the invention, the method is iterative and the main steps are applied several times with different numbers of nodes.

Schematically, in order to start using the method, the operator:
Indicates in steps 10 the invariant characteristics of the zones which he/she desires to protect (for example dimensions, initial energy contained in the nodes)
Initializes in steps 12 a set of constraint CPCs and of objective CPOs which he/she desires to attain on the performance criteria of each zone.

After iteration of the method, the operator:
Analyzes the results by viewing the zones which require more nodes and/or a relaxation of the CPC constraints and of the CPO objectives.

As long that this has not resulted in a feasible configuration meeting his/her operational needs on each zone (for example: there remains zones where no operating point meets the constraints, or zones where the objective on the CP to be optimized is not attained), the steps of the method are reiterated:
By increasing in step 14 the number of nodes used in certain zones, provided that nodes may be reallocated to them.
By relaxing in step 16 some of the constraints or objectives on the CP to be optimized in these zones.

The global method (procedure PROC_GLOBAL_{Z}) is called as follows. The corresponding inputs and outputs as well as its operation are detailed hereafter.

PROC_GLOBAL_{Z}(Nₜₒₜ,{CPC*⁽ⁱ⁾,CPO_{obj}⁽ⁱ⁾,POS_{N0}⁽ⁱ⁾,Nₛᵤₚₚ⁽ⁱ⁾,Nₘₐₓ⁽ⁱ⁾,d⁽ⁱ⁾} for any zone Zᵢ)={(POS_{Nreq}⁽ⁱ⁾,PFₒₚₜ⁽ⁱ⁾,CONF⁽ⁱ⁾,N_{req}⁽ⁱ⁾,MS⁽ⁱ⁾) for any zone Zᵢ}

Inputs

The operator defines (the corresponding steps of FIG. 3 are recalled between brackets):
Nₜₒₜ. The total number of nodes which he/she wishes to place (step 20).
For each node j (steps 10)
   Constants on the nodes:
      Ej: the initial energy contained in the battery of node j
For each zone Z, (steps 10)
   Constants on the proportioning of the sub-system:
      d⁽ⁱ⁾: the size of the zone
   Number and positions of the nodes:
Nₛᵤₚₚ⁽ⁱ⁾ the number of sensors to be deployed, the position of which is not imposed by the operator
(optional) POS_{N0}⁽ⁱ⁾: the imposed position of a set of nodes
(optional) Nₘₐₓ⁽ⁱ⁾: the maximum number of nodes to be deployed in the zone.
   Operational constraints: (steps 12)
CPC*⁽ⁱ⁾: the “threshold” value of the CP Constraints.
(optional) values of low level parameters of the system (for example βₛₑₙₛ the proportion of the time during which the observation module is active, or β_{com} the proportion of the time during which the radio transmission module is active).
   Strategy: (steps 12)
CPO⁽ⁱ⁾: the type of CP to be optimized. For example CPO={L, D}.
(optional) CPO_{obj}⁽ⁱ⁾ the <<objective>> value of the CP(s) to be optimized

The total sum of the Nₛᵤₚₚ⁽ⁱ⁾ is less than or equal to Nₜₒₜ.

Outputs

The operator obtains at the output:
N_{realloc}: the number of nodes which may be reallocated.
For each zone Zᵢ
POS_{Nreq}⁽ⁱ⁾: the positioning of the set of nodes
PFₒₚₜ⁽ⁱ⁾: the optimum operating point considering the CPC*s (and CPO_{obj} if the latter is defined), i.e. the CP values which meet CPC* and CPO_{obj} with the low level system configuration of the UGS network corresponding to these values.
CONF⁽ⁱ⁾: the parameterization of the system (for example βₛₑₙₛ, β_{com}) corresponding to the operating point PFₒₚₜ⁽ⁱ⁾
N_{req}⁽ⁱ⁾: the minimum number of nodes required in the zone
MS⁽ⁱ⁾ Output pattern of PROC_{Zi}(CPC*⁽ⁱ⁾, CPO_{obj}⁽ⁱ⁾, POS_{N0}⁽ⁱ⁾, Nₛᵤₚₚ⁽ⁱ⁾, Nₘₐₓ⁽ⁱ⁾, d⁽ⁱ⁾)

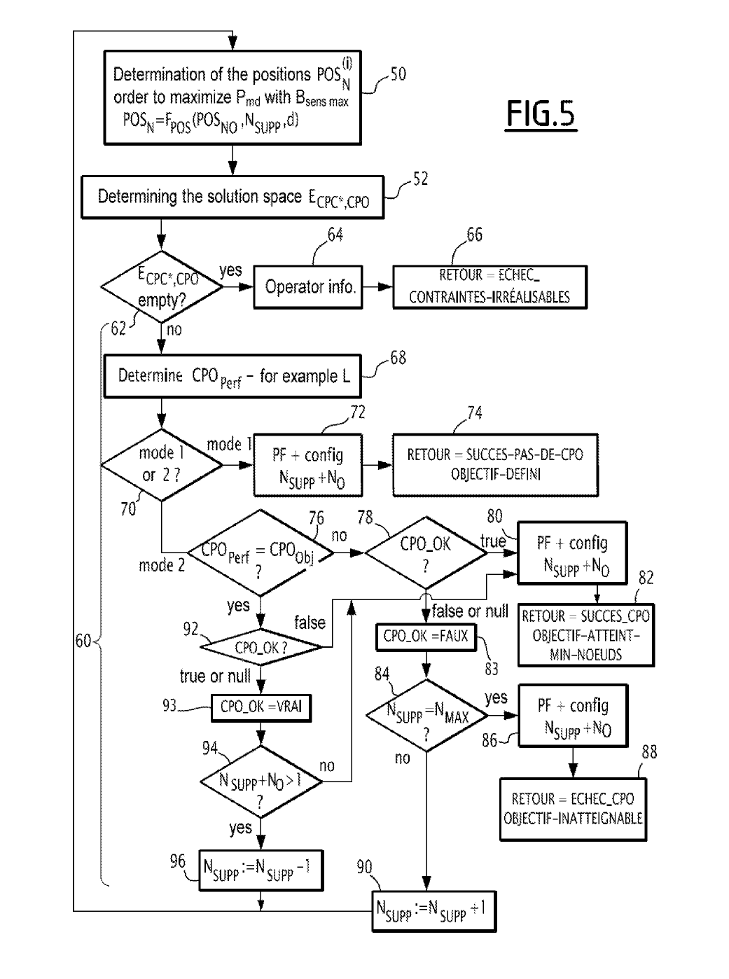

The method operates iteratively by requesting an interaction with the operator at the end of each iteration. In particular, an iteration of the global method consists of:
Applying an optimization process per zone, by applying to steps 22 a procedure PROC_{Zi} described with reference to FIG. 5 or PROC_MAX-SURFACE_{Zi} on each of the zones.
Interacting with the operator by showing him/her the results on the whole of the zones, notably in the zones which require more nodes and/or a relaxation of the constraints and objectives.
Recording the new inputs to be applied on the zones (for example adding nodes, making the constraints more flexible).

As long as a feasible configuration meeting the operational needs of the operator is not attained on each zone, the method is reiterated by initializing or modifying the set of constraints and objectives which the operator wishes to attain.

The method may thus be expressed by the following algorithm always described with reference to FIG. 3.
RETOUR=CONTINUER /* RETURN=CONTINUE */
PROBLEME=NULL /*PROBLEM=NULL*/
   (the variable PROBLEME indicates whether a zone cannot satisfy the CPs with the N_{req}⁽ⁱ⁾)
Tant que RETOUR=CONTINUER /* while RETURN=CONTINUE */
   For each zone Zᵢ,

Execute in step 22 the optimization process per zone: PROC_{Zi}

Store in step 24:

N_{req}⁽ⁱ⁾ the number of nodes required in the zone

POS_{N}⁽ⁱ⁾ the positioning of the nodes in the zone

PFₒₚₜ⁽ⁱ⁾: the optimum operating point if it has been determined

CONF⁽ⁱ⁾: the parameterization of the corresponding system

MS⁽ⁱ⁾: the output pattern of PROC_{Zi}

If the output pattern of PROC_{Z}, is

### ECHEC_CONTRAINTES-IRREALISABLES /*FAILURE_UNACHIEVABLE-CONSTRAINTS */or ECHEC_CPO-OBJECTIF-INATTEIGNABLE /*FAILURE_CPO-UNATTAINABLE-OBJECTIVE */

PROBLEME=VRAI /*PROBLEM=TRUE */
   A test is conducted in step 26 in order to determine according to the value of the variable PROBLEME, whether the CPs cannot be attained in at least one zone.

### If PROBLEME=NULL /* PROBLEM=NULL */

Display, in step 28, for each zone: N_{req}⁽ⁱ⁾, PFₒₚₜ⁽ⁱ⁾, POS_{N}⁽ⁱ⁾, CONF⁽ⁱ⁾ and the output pattern.

RETOUR=STOP /* RETURN=STOP */else:

Calculate, in step 30, the required accumulation of nodes at least on the whole of the zones and the number of nodes which may be potentially reallocated N_{realloc}.

In step 32, a test is conducted on the value of N_{realloc},

If N_{realloc} is zero

The operator is informed in step 14 that it is impossible to configure a UGS network over the whole of the zones within the limit of the available nodes and considering the optionally defined constraints and objectives.

Suggest in step 14 relaxation of the optionally defined constraints and/or objectives in the zones for which the output pattern is ECHEC_CONTRAINTES-IRREALISABLES or ECHEC_CPO-OBJECTIF-INATTEIGNABLE

### /* FAILURE_UNACHIEVABLE-CONSTRAINTS OR FAILURE_CPO-UNATTAINABLE-OBJECTIVE*/

RETOUR=STOP /* RETURN=STOP */

### Else

The nodes available at the zones having returned ECHEC_CONTRAINTES-IRREALISABLES /* FAILURE_UNACHIEVABLE-CONSTRAINTS */ or ECHEC_CPO-OBJECTIF-INATTEIGNABLE /* FAILURE_CPO-UNATTAINABLE OBJECTIVE */ are reallocated to the operator in step 16.

In steps 10 and/or 12, store in memory the new allocation of nodes per zone and/or the new constraints and/or the new objectives.

PROBLEME=NULL /* PROBLEM=NULL */

Start again

### Iteration Example of the Global Method

FIG. 4 shows the course of the global procedure on three zones where 2 iterations will be necessary for finding a feasible configuration over the whole of the zones.

The operation of the optimization process on a zone Z noted as PROC_{Z} will now be described with reference to FIG. 5. It may be instantiated according to the two modes MODE1 and MODE2 described earlier.

The inputs and corresponding outputs are detailed hereafter.

PROC_{Z}(CPC*,CPO_{obj},POS_{N0},Nₛᵤₚₚ,Nₘₐₓ,d)=(POS_{N}PFₒₚₜ,N_{req},CONF,MS)

### Inputs

The following inputs may be initialized by the operator upon the first call to the procedure, or incremented or decremented during an iteration of the procedure.

The inputs are distributed as follows:
Constants on the nodes:
   Ej: the initial energy contained in the battery of the node j
Constants on the proportioning of the system:
   d: the dimension of the zone (for example the 1,000 m width of the square zone to be monitored)
Number and positions of the nodes:
   Nₛᵤₚₚ: the number of sensors to be deployed, the position of which is not imposed by the operator.
   (optional) POS_{N0}: the desired position of a sub-set N₀ of nodes.
   (optional) Nₘₐₓ: the maximum number of nodes to be deployed in the zone if the operator has a limited number of nodes
Operational constraints
   CPC*: the “threshold” value of the CP constraints. For example:
P_{md}*=10% (Non-detection probability of less than 10%)
D*=100 ms (Delay for transmitting the alert to the gateway node of less than 100 ms)
L*=30 days (Lifetime of the system greater than 30 days)
   (optional) If need be, forcing the low level parameters of the system:
βₛₑₙₛ=10% (proportion of the time during which the observation module is active, here 10%).
β_{comm}=10% (proportion of the time during which the radio transmission module is active, here 10%).
Strategy
   CPO: the type of CP to be optimized. For example, CPO={L, D}.
   (optional) CPO_{obj}: the objective value of the CP to be optimized.

### Outputs

The method produces at the output:
POS_{N}: the positioning of the whole of the required nodes
PFₒₚₜ: the optimum operating point considering the CPC* and CPO_{obj} (if this parameter is defined), i.e. the CP values which satisfy CPC* and CPO_{obj} (if this parameter is defined), with the low level configuration of the UGS network corresponding to these values.
CONF: the parameterization of the system (for example βₛₑₙₛ, β_{com}) corresponding to the operating point PFₒₚₜ
N_{req}: the required number of nodes. Depending on the mode in which the process operates, this number of nodes may differ from the number of initially allocated nodes at the input (in MODE2, the process may determine that a number greater than, or less than the initial Nₛᵤₚₚ is required for satisfying the objective value on CPO)
MS: the output pattern
   ECHEC_CONTRAINTES-IRREALISABLES: there is no way for configuring the systems so that an operating point satisfies the CPC* <<threshold>> values
   ECHEC_CPO-OBJECTIF-INATTEIGNABLE: it is not possible within the limit of the number of available nodes to find an operating point such that the objective on CPO is attained.
   SUCCES_PAS-DE-CPO-OBJECTIF-DEFINI /*SUCCESS_NO-DEFINED-CPO-OBJECTIVE */: for the number of nodes used, the initial Nₛᵤₚₚ, at least one operating point exists which meets the constraints. The procedure then indicates the best of the operating points considering the CPO (the optimum value of CPO is unimportant).
   SUCCES_CPO-OBJECTIF-ATTEINT-MIN-NOEUDS: (SUCCES_CPO-OBJECTIVE-ACHIEVED-MIN-NODES): the required number of nodes N_{req} (possibly different from the initial Nₛᵤₚₚ) is minimum so that the best attainable operating point satisfies both the constraints and the objective value on CPO.

For a given number of nodes, the process PROC_{Z} determines in a zone:
The optimum geographical position of the whole of the nodes.
The optimum operating point considering CPO and threshold values on the CPCs (i.e., CPC*), as well as the parameterization of the corresponding system.

In MODE 1, the process PROC_{Z} shows the above results to the operator at the end of an iteration of the procedure PROC_GLOBAL_{Z}.

In MODE2, the process PROC_{Z} iterates on the number of nodes used until the minimum required number of nodes is determined in order to attain an <<objective>> value on the CPOs. For this number of nodes, the process PROC_{Z} shows the results to the operator at the end of an iteration of the procedure PROC_GLOBAL_{L}.

The method operates stepwise as follows:
RETOUR=CONTINUER; CPO_OK=NULL /*RETURN=CONTINUE; CPO_OK=NULL */
Tant que RETOUR=CONTINUER /* while RETURN=CONTINUE */

In step 50, the position of the whole of the nodes noted as POS_{N} is determined

POS_{N} is the whole of the positions of the nodes which maximize the non-detection probability in the hypothetical situation when the sensor module of each node is constantly active (i.e., βₛₑₙₛ=1).

### POS_{N}=F_{POS}(POS_{NO}, Nₛᵤₚₚ, d)

wherein POS_{N} is the geographical position of the set of the nodes deployed in the zone. This set includes the N₀ nodes, the position of which is set by the operator and the additional Nₛᵤₚₚ nodes to be placed in the zone.

Keep POS_{N} in memory

and wherein Fₚₒₛ is the optimization technique described below.

The optimization function Fₚₒₛ is applied in order to determine the optimum positioning of a certain number of sensors inside a zone.

In order to suggest a positioning of the nodes in a coverage zone, the non-dominated sorting genetic algorithm techniques known per se are applied. Fₚₒₛ then determines the whole of the positions of the nodes such that the value of P_{md} is minimum in the case when the sensor modules of the nodes are permanently active.

It is possible to set upon input the position of a certain number of nodes.

F_{POS} inputs
(optional) the predetermined positioning of a subset of nodes POS_{N0}
the number of nodes, the position of which is not imposed by the operator
d: the dimension of the zone

F_{POS} outputs
POS_{N0}: the position of the set of nodes
   By knowing POS_{N}, the space of the solutions noted as E_{CPC*,CPC}, is determined in step 52.

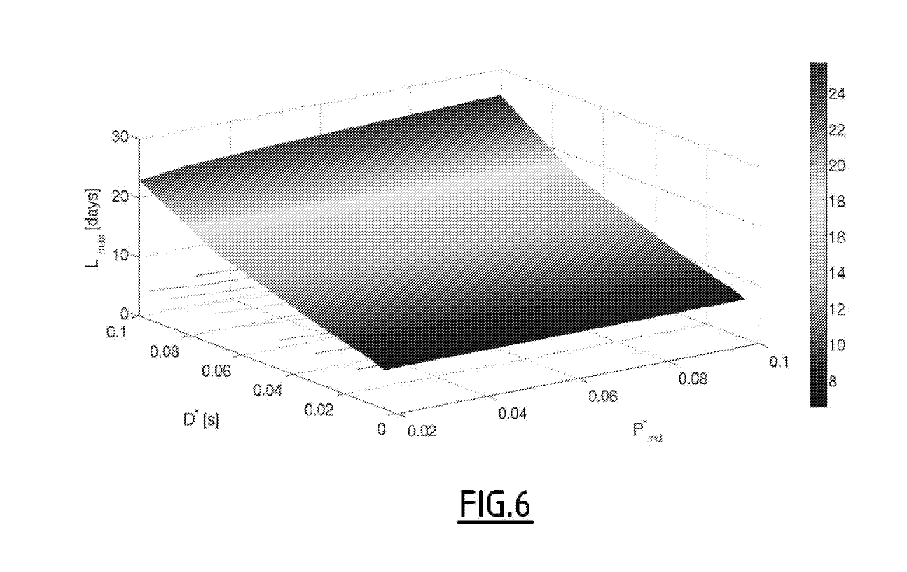

This space gives the whole of the particular realizations of CPO which are obtained for any CPC below the CPC* “threshold” values. This set may be viewed as a multi-dimensional graph G as illustrated in FIG. 6.

E_{CPC*,CPO}={CPC⁽⁰⁾, CPO⁽⁰⁾ such that CPO⁽⁰⁾=F_{OPT}(CPC⁽⁰⁾, POS_{N})
for any CPC⁽⁰⁾ which satisfies CPC*}

wherein F_{OPT} designates a single- or multi-objective optimization technique described below.

By using the analytical models described earlier, two optimization methods may be used depending on whether it is sought to determine the optimum value of one or more performance criteria subject to certain constraints.

The applied optimization method is called F_{OPT}
When a single performance criterion has to be optimized, F_{OPT} designates a single-objective optimization technique, such as optimization by gradient descent.
The latter may be applied if the whole of the identified equations for modeling the systems forms a convex set.
When two or more performance criteria have to be optimized, F_{OPT} designates a multi-objective optimization technique, which allows simultaneous optimization of contradictory objective functions, subject to certain optional constraints. For example, we may use a classification method based on Pareto optimality, involving recent techniques, i.e. the Non-dominated Sorting Genetic Algorithm-II)

F_{OPT} inputs
the positioning of the set of nodes POS_{N}
CPC⁽⁰⁾: the set of the values of the CP constraints
CPO: the set of the CPs, the value of which has to be optimized
d: the dimension of the zone

Fₒₙ outputs
CPOₒₚₜ⁽⁰⁾: the set formed with the optimum values for each CP included in CPO

For example, if the operator chooses to have:
CPC={D, P_{md}} with CPC*={D*=100 ms, P_{md}*=10%}
CPO={L}

Then E_{D*=100 ms,Pmd=10%, L}={Lₒₚₜ⁽⁰⁾, (P_{md})ₘₐₓ⁽⁰⁾, Dₘₐₓ⁽⁰⁾ such that:

Lₒₚₜ⁽⁰⁾=F_{OPT}((P_{md})ₘₐₓ⁽⁰⁾,Dₘₐₓ⁽⁰⁾) and (P_{md})ₘₐₓ⁽⁰⁾<=P_{md}* and Dₘₐₓ⁽⁰⁾<=D*)}

Still in this example, the graph G is then such that in FIG. 6, G notably includes points indicating that:
The maximum lifetime is 18 days with (P_{md})ₘₐₓ=2% and Dₘₐₓ=80 ms.
The maximum lifetime is 13 days with (P_{md})ₘₐₓ=10% and Dₘₐₓ=60 ms.
   An exploration of the results is carried out during the phases 60.

a) If: ECPC*, CPO is void during step 62

For example, there exists no PF with 5 nodes in the zone such that Pmd<1% and D<15 ms. It is then impossible to determine an achievable value, and a fortiori an optimum value for the lifetime.

Tell the operator in step 64 that it is possible to configure and operate the UGS network in an operating point such that the threshold values on the CP constraints are satisfied.

Suggest in step 64 that the operator try again by modifying the initial input parameters. For example, the operator may:
Increase the number of nodes Nₛᵤₚₚ
Relax the “threshold” values imposed to the CPCs.
RETOUR=ECHEC_CONTRAINTES-IRREALISABLES (step 66)
/* RETURN=FAILURE_UNACHIEVABLE-CONSTRAINTS */

b) Else: E_{CPC*,CPO} is non-void (CPO_{perf} exists) (test carried out in 62)

In step 68 the most performing value of CPO_{perf} is determined on the space of the solutions E_{CPC*,CPO} (if it is non-void)

The most performing value of CPO on the space of solutions E_{CPC*,CPO} is noted as CPO_{perf}

For example, L_{perf} (P_{md}*,D*)=max Lₒₚₜ⁽⁰⁾ on the set E_{D*,Pmd*, L}. In the example L_{perf} (P_{md}*=10%,D*=100 ms)=25d considering E_{D*=100ms,Pmd*=10%, L}

The optimum operating point is noted as PFₒₚₜ such that CPO=CPO_{perf} and CONF is the parameterization of the system with which PF_{opt.} may be attained.

Determining and keeping PFₒₚₜ and CONF in memory.

A test is carried out in step 70 for defining the return mode.

i) If no objective was defined on the CPOs (MODE1), i.e. the operator seeks to operate the UGS network in a PF meeting the constraints (CPC*) and limits himself/herself to knowing the most performing value on a CP to be optimized (CPO).

Displaying, in step 72, the optimum operating point and the configuration obtained in step 54, as well as the topology obtained in step 50 and the number of nodes used (Nₛᵤₚₚ+N₀)

RETOUR=SUCCES_PAS-DE-CPO-OBJECTIF-DEFINI (step74)

/*RETURN=SUCCESS_NO-DEFINED-CPO-OBJECTIVE */

Start again

ii) Else: an objective CPO_{obj} was defined on CPO (MODE2)

A test is carried out in step 76 for defining the attaining of the objective CPO_OK.

(1) If CPO_{perf} does not satisfy CPO_{obj} (if the best performance attainable on the CP to be optimized is below the objective)
If CPO_OK=VRAI /*If CPO_OK=TRUE*/ (step 78)

Display in step 80 the optimum operating point and the configuration obtained in step 54 at the preceding iteration, as well as the topology obtained in step 50 and the number of nodes used (Nₛᵤₚₚ+N₀) at the preceding iteration.

RETOUR=SUCCES_CPO-OBJECTIF-ATTEINT-MIN-NCEUDS (step 82)

### /*RETURN=SUCCESS_CPO-OBJECTIVE-ACHIEVED-MIN-NODES*/

Start again
Else (i.e. CPO_OK=FAUX /*CPO_OK=FALSE*/ or CPO_OK=NULL)

CPO_OK=FAUX (step 83) /*CPO_OK=FALSE*/

A test is carried out in step 84 for defining whether Nₛᵤₚₚ is equal to the available maximum optionally defined in step 84.

If Nₛᵤₚₚ is equal to the optionally defined available maximum.

Display in step 86 the optimum operating point and the configuration obtained in step 54, as well as the topology obtained in step 50 and the number of nodes used (Nₛᵤₚₚ+N₀)

RETOUR=ECHEC_CPO-OBJECTIF-INATTEIGNABLE (step 88)

/* RETURN=FAILURE_CPO-UNATTAINABLE-OBJECTIVE*/

Else
Increment N_{Supp} in step 90
Start again

(2) Else: CPO_{perf} satisfies CPO_{obj} in step 76 (i.e. the best attainable performance on the CP to be optimized is beyond the objective)

A test on the value of CPO_OK is carried out in step 92
If CPO_OK=FAUX /* CPO_OK=FALSE */
then:

Display, in step 80, the optimum operating point and the configuration obtained in step 54, as well as the topology obtained in step 50 and the number of nodes used (Nₛᵤₚₚ+N_{O})

RETOUR=SUCCES_CPO-OBJECTIF-ATTEINT-MIN-NCEUDS (step 82)

/*RETURN=SUCCESS_CPO-OBJECTIVE-ACHIEVED-MIN-NODES*/

Start again

Else (i.e. CPO_OK=VRAI /*CPO_OK=TRUE*/ OR CPO_OK=NULL)

CPO_OK=VRAI (step 93) /*CPO_OK=TRUE*/

A test on the number of nodes used is compared with unity in step 94.

If the number of nodes is strictly greater than 1
Start again by using less nodes (i.e. decrementing Nₛᵤₚₚ) in step 96

Else

Display in step 80 the optimum operating point and the configuration obtained in 3), as well as the topology obtained in 1) and the number of nodes used (Nₛᵤₚₚ+N₀)

RETOUR=SUCCES_CPO-OBJECTIF-ATTEINT-MIN-NITUDS (step 82)

/*RETURN=SUCCESS_CPO-OBJECTIVE-ACHIEVED-MIN-NODES*/

Start again

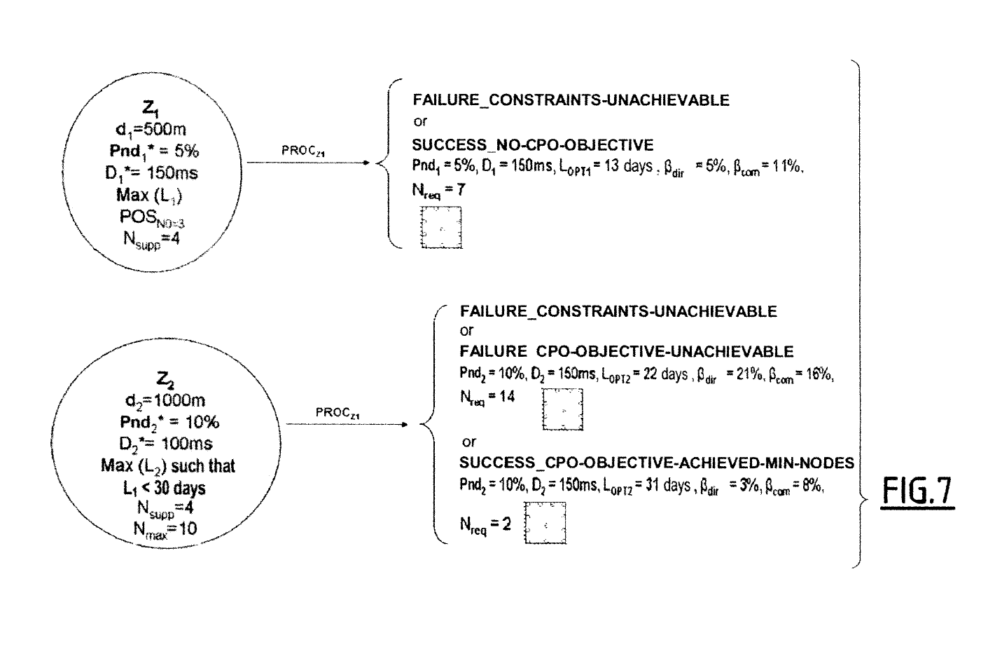

FIG. 7 shows the outputs which may be produced by the procedure PROC_{Z} on two zones, each of them using a call mode of the procedure.

In the zone Z₁, MODE1 is used because the operator wishes to know the configuration which as a priority meets the constraints on P_{md} and D, and secondarily gives the best lifetime. For the given number of nodes, the process determines the best operating point if it exists.

In the zone Z₂, MODE2 is used because the operator wishes to know the configuration which meets the constraints on P_{md} and D, and such that the best lifetime is beyond an objective. After a few iterations, the process determines the minimum required number of nodes so that the best operating point if possible satisfies both the constraints and the objective. This minimum number of nodes is possibly greater than or less than the number of nodes initially allocated to the zone.

An alternative noted as PROC_MAX-SURFACE_{Z} of the procedure PROC_{Z}, illustrated in FIG. 5, consists of the determining the maximum surface area of a zone such that there exists an operating point meeting the performance criteria.

For example, by having 15 nodes, the operator wishes to know what is the maximum coverage of the zone around a given location, which will guarantee him/her that the non-detection probability is less than 10%.

The procedure is noted as PROC_MAX-SURFACE_{Z}(CPC*, Nₛᵤₚₚ) or, in order to simplify PROC_MAX-SURFACE_{Z} The procedure operates as follows, the inputs and corresponding outputs are detailed hereafter.

PROC_MAX-SURFACE_{Z}(CPC*,C,N)=(POS_{N}PFₒₚₜ,CONF,MS)

### Inputs

The following inputs are initialized by the operator upon the first call to the procedure.

The inputs are distributed as follows:
Constants on the proportioning of the system:
   dₘᵢₙ: the minimum dimension of the zone (for example a width of the square zone to be monitored of at least 1 m)
   C: the position of the centre of the zone
   Ei: The initial energy contained in the batteries
Number of nodes:
   N: the number of sensors to be deployed, the position of which is not imposed by the operator
Operational constraints
   CPC*: the “threshold” value of the CP constraints. For example:
      P_{md}*=10% (Non-detection probability of less than 10%)
      (optional) If need be, forcing the low level parameters of the system.
Strategy
   CPO: the type of CP to be optimized. For example, CPO={L, D}.

### Outputs

The procedure produces as output:
dₘₐₓ: the maximum size of the zone
PFₒₚₜ: the optimum operating point considering the CPC*, i.e. the CP values which meet CPC* with the low level configuration of the UGS network corresponding to these values.
CONF: the parameterization of the system (for example βₛₑₙₛ, β_{com}) corresponding to the operating point PFₒₚₜ
POS_{N}: the positioning of the whole of the nodes in the obtained zone of maximum size.
MS: the output pattern
   ECHEC_IMPOSSIBLE-POUR-TAILLE-MINIMALE
   /* FAILURE_IMPOSSIBLE-FOR-MINIMUM-SIZE*/: There is no way for configuring the system so that an operating point meets the CPC* <<threshold>> values for the minimum size of the zone.
   SUCCES_TAILLE-MAXIMALE-ATTEINTE:
   /* SUCCESS_MAXIMUM-SIZE-ATTAINED*/

### Progression

For a given number of nodes, the process PROC_MAX-SURFACE determines in a zone:
The optimum geographical position of the whole of the nodes
The optimum operating point considering CPO and the <<threshold>> values on the CPCs (i.e., CPC*), as well as the parameterization of the corresponding system

As long as there exists an optimum operating point, the process PROC_MAX-SURFACE iterates on the size of the zone until the maximum size is determined so that an optimum operating point exists. For this maximum size, the process shows the results to the operator at the end of an iteration of the procedure PROC_GLOBALZ.

The method operates stepwise as follows:
RETOUR=CONTINUER; /*RETURN=CONTINUE*/
d=dₘᵢₙ
dₛₜₑₚ, the incrementation step of d

Tant que RETOUR=CONTINUER /*While RETURN=CONTINUE*/

### 1) Determining the Position of the Set of Nodes Noted as POS_{N}

POS_{N} is the set of the positions of the nodes which minimizes the non-detection probability in the hypothetical situation when the sensor module of each node is permanently active (i.e., βsens=1)

### POS_{N}=F_{POS}(N, d)

wherein F_{POS} is the optimization technique described in section 6.4 “Optimization techniques”.
Keeping POS_{N} in memory.
2) with the Knowledge of POS_{N}, Determine the Space of Solutions Noted as E_{CPC*CPO}.

This space gives the whole of the particular realizations of CPO which are obtained for any CPC beyond the CPC* “threshold” value. This set may be viewed as a multi-dimensional graph G.

E_{CPC*,CPO}={CPC⁽⁰⁾, CPO⁽⁰⁾ such that CPO⁽⁰⁾=F_{OPT}(CPC⁽⁰⁾, POS_{N})
For any CPC⁽⁰⁾ which satisfies CPC*}

wherein F_{OPT} designates a single- or multi-objective optimization technique as described earlier.

### 3) Exploration of the Results

a) If: E_{CPC*,CPO} is void.

For a zone centered on C and of size d, it is impossible to configure and operate the UGS network in an operating point so as to meet the constraints.

(For example, in a zone with a width of 1,000 m where 5 nodes are deployed, it is impossible to find a configuration of the UGS network such that Pmd<10%.)

If d=dₘᵢₙ

For the minimum size of the zone, it is impossible to configure and operate the UGS network in an operating point such that the constraints are satisfied.
RETOUR=ECHEC_IMPOSSIBLE-POUR-TAILLE-MINIMALE
/* RETURN=FAILURE_IMPOSSIBLE-FOR MINIMUM-SIZE */
Start again.

Else

dₘₐₓ=d−dₛₜₑₚ (Determine the maximum size of the zone)

Determine the most performing value of the CPO, noted as CPO_{perf}, for the space of solutions E_{CPC*,CPO} kept in memory at the preceding iteration.
Display the optimum operating point, the topology kept in memory at the preceding iteration and the obtained maximum size dₘₐₓ.

RETOUR=SUCCES_TAILLE-MAXIMALE-ATTEINTE

/* RETURN=SUCCESS_SIZE-MAXIMUM-ATTAINED */

Start again.

b) Else: E_{CPC*,CPO} is non-void

d=dₘᵢₙ+dₛₜₑₚ (Increment the size of the zone)

Store the graph G in memory representing E_{CPC*,CPO} and the topology determined in 1).

Start again

The optimization process is achieved on a description of the system in the form of a “system model”. This model consists of functions or relationships between the parameters describing the operation of the system. It allows performance indicators to be derived on which the operator places objectives (for example maximization of the lifetime of the system L). The method may for example include the following functions:
P_{md}=f (Pos_{N}, βₛₑₙₛ): Non-detection probability as a function of the position of the nodes Pos_{N} and of the proportion of the time during which the observation module is active, βₛₑₙₛ. Pos_{N} has an influence on the capability of a sensor of detecting the target when it is within range.
D=h(Pos_{N}, β_{comm}): Delay for transmitting the alerts versus the position of the nodes Pos_{N} and the proportion of the time during which the radio transmission module is active β_{comm}. Pos_{N} has an influence on the number of radio hops and β_{comm} on the delay at each hop in the case of the use of X-MAC for example.
L=g(β_{comm}, βₛₑₙₛ, N_{target}): Lifetime of the system versus the dedicated effort level for the sensor portion (for example βₛₑₙₛ) and for the network portion (for example β_{comm}), and versus the average number of targets detected per day N_{target}.

Subsequently in this section, 3 functions are shown which characterize the operation of the system. These functions characterize the non-detection probability P_{md}, the lifetime of the system L and the alert transmission delay D. The extension of the formulation of the non-detection probability P_{md} proposed by [Lazos09] within the framework of the use of sleep cycles, forms a contribution of this document. The remainder of the formulations is taken again from the state of the art.

It should be noted that optimization techniques used for determining the operating points of the system are generic so that other models may be integrated into the system. This may allow refining of the modeling of the system and/or extension of the performance indicators characterizing the operation of the system.

Assumptions

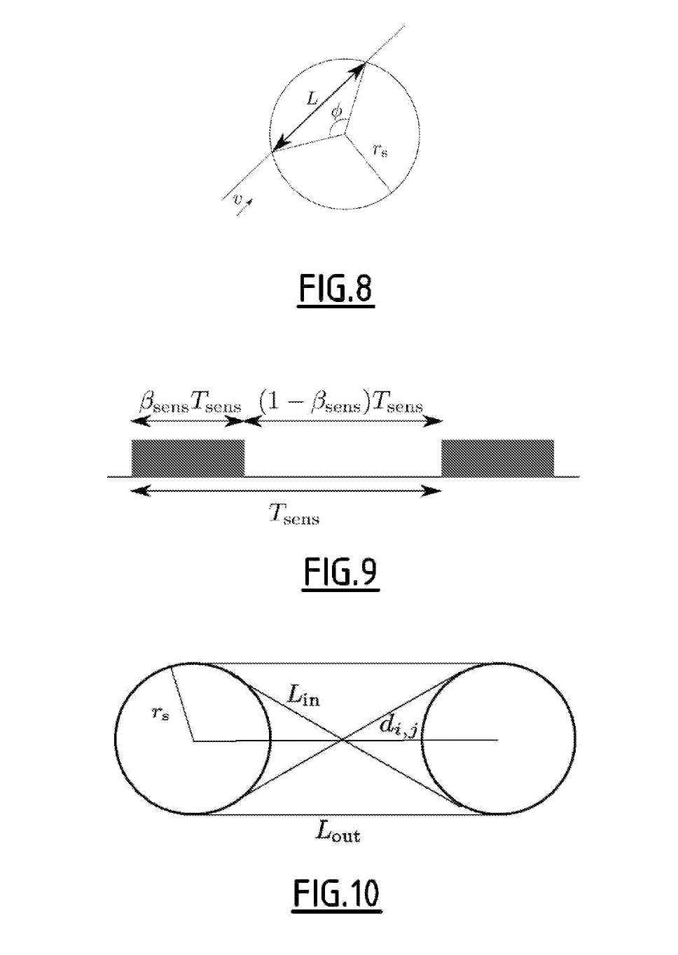

In order to be able to calculate P_{md} (the non-detection probability), the following assumptions are made. The zone of interest to be monitored is a square of width dₛ (dimension: [m]). N sensor nodes having circular coverages of radius rₛ illustrated in FIG. 8 are then deployed for detecting the presence of targets in the zone. The relevant behavioral model of targets assumes a uniform rectilinear movement where the trajectory is characterized by an arrival angle θ. The constant speed is v (dimension: [m/s]). As the entry point of these targets is unknown a priori, it is randomly selected on the contour of the zone.

The sensor nodes include at least two sub-modules: (i) the sensor module (for example a transducer) and (ii) the wireless communication module. In order to reduce the consumption of both of these modules, duty cycles are used. These cycles alternatively consist of a phase during which the module is active and a phase during which the module is inactive. They are characterized by two parameters: the period of the cycle Tₛₑₙₛ (dimension: [s]) and the proportion of the time B sens in [0,1] during which the module is active as illustrated in FIG. 9. In the remainder of the document, the parameters are (βₛₑₙₛ, Tₛₑₙₛ) and (β_{comm}, T_{comm}) for respectively the sensor module and the communication module. The consumed power when the sensor module is active is Ωₛₑₙₛ. In the remainder of the calculation, we also consider that all the sensor nodes have the same values for the parameters rₛ, βₛₑₙₛ, and Tₛₑₙₛ.

Modeling the Non-Detection Probability P_{md}

Let us consider N sensor nodes placed in a certain way and let us consider βₛₑₙₛ=1, the detection probability corresponding to the probability that the trajectory of the target crosses at least one sensor P_{d} is expressed in the following way:

P_{d}=1−P_{md}=P(l∩ [symbol] ₁∪ [symbol] ₂∪ . . . ∪ [symbol] _{N})) (1)

wherein l is the line corresponding to the trajectory of the target, Aᵢ the surface area of the range of the sensors of the node i.

Equation (1) may be rewritten by using the Feller's inclusion-exclusion principle, as the sum of the joint probabilities that a line cuts various sensor coverages. One then has:

$${P}_{d} = {\sum }_{i = 1}^{N} P ( 𝓁 ⋂ {i}_{} \neq 0 ) - {\sum }_{i , ji < j}^{N} P ( 𝓁 ⋂ {i}_{} ⋂ {j}_{} \neq 0 ) + … + {( - 1 )}^{N} P ( 𝓁 ⋂ {1}_{} ⋂ {2}_{} … {2}_{} {N}_{} \neq 0 ) \qquad ( 2 )$$

According to [Lazos09], the case of deterministic deployment of the sensor nodes cannot be easily calculated analytically. On the other hand, the upper and lower limits may be calculated. According to the inequalities of Bonferroni, the following lower and upper limits may be calculated:

P_{d}_{₁}−P_{d}_{₂}≦P_{d}≦P_{d}_{₁} (3)

wherein P_{d1} and P_{d2} are expressed as follows:

$$\begin{matrix}{P}_{{d}_{1}} = {\sum }_{i = 1}^{N} \underbrace{P ( 𝓁 ⋂ {i}_{} \neq 0 )}_{{=}^{△} {m}_{1} ( i )} = {\sum }_{i = 1}^{N} {m}_{1} ( i ) . & ( 4 ) \\ {P}_{{d}_{2}} = {\sum }_{i , j \text{:} i < j}^{N} \underbrace{P ( 𝓁 ⋂ {i}_{} ⋂ {j}_{} \neq 0 )}_{{=}^{△} {m}_{2} ( i , j )} = {\sum }_{i , ji < j}^{N} {m}_{2} ( i , j ) & ( 5 )\end{matrix}$$

The equations (4) and (5) do not take into account βₛₑₙₛ. Subsequently in this calculation, we extend P_{d1} and P_{d2} in order to take into account the duty cycles of the sensor module which are then expressed as:

$$\begin{matrix}{P}_{{d}_{1}} = {\sum }_{i = 1}^{N} {m}_{1} ( i ) \cdot P \{ {Activity}_{i} \} & ( 6 ) \\ {P}_{{d}_{2}} = {\sum }_{i , ji < j}^{N} {m}_{2} ( i , j ) \cdot P \{ {Activity}_{i , j} \} & ( 7 )\end{matrix}$$

wherein the new introduced factors are:
P{Activityᵢ}: the probability that the sensor module of the node i is or becomes active when the target crosses its coverage zone.
P{Activity_{i,j}}: the probability that the sensor modules of the nodes i and j are or become active when the target crosses their coverage zones.

In order to estimate the lower and upper limits of equation (3), P_{d1} and then P_{d2} are calculated.

Formulation of P_{d1}

In the case when the coverage zone of the sensor module is a disk of radius rₛ, we have m₁(i)=2πrₛ/4dₛ and the factor P{Activityᵢ} may be calculated according to the results shown by [Meda09] (equation 10).

Formulation of P_{d2}

According to equation (7), P_{d2} is expressed as follows:

$${P}_{{d}_{2}} = {\sum }_{i , ji < j}^{N} {m}_{2} ( i , j ) \cdot P \{ {Activity}_{i , j} \}$$

i—Calculation of m2(i,j)

The term m₂(i,j)=P(l∪Aᵢ∪Aⱼ≠0) expresses the probability that the trajectory of the target cuts the ranges of both nodes i and j.

Considering the possible overlapping of the coverages of nodes i and j, the general formulation of m₂(i,j) is as follows:

$${m}_{2} ( i , j ) = \{ \begin{matrix}\frac{{L}_{i} + {L}_{j} - {L}_{out} ( {d}_{i , j} )}{{L}_{0}} & {i}_{} ⋂ {j}_{} \neq 0 \\ \frac{{L}_{in} ( {d}_{i , j} ) - {L}_{out} ( {d}_{i , j} )}{{L}_{0}} & {i}_{} ⋂ {j}_{} = 0\end{matrix} \qquad ( 8 )$$

wherein the corresponding terms are, and as illustrated in FIG. 8:
Lᵢ and Lₖ: the perimeters of the respective coverage zones of the nodes i and j,
d_{i,j} the distance between both nodes,
Lᵢₙ: the length of the line forming a <<figure of eight>> surrounding both coverage zones
Lₒᵤₜ: the length of the line surrounding the two coverage zones without crossing each other
L₀: the perimeter of the monitored zone

According to our assumptions, the formulation of m2(i,j) is obtained by knowing that Lᵢ=Lⱼ=2πrₛ, L₀=4 d_{c} and on the other hand according to [Lazos09] (equations 37 and 38):

$${L}_{out} ( {d}_{i , j} ) = 2 π {r}_{s} + 2 {d}_{i , j}$$

$${L}_{in} ( {d}_{i , j} ) = 2 {r}_{s} [ 2 π - 2 arccos ( \frac{2 {r}_{s}}{{d}_{i , j}} ) ] + 4 \sqrt{\frac{{d}_{i , j}^{2}}{4} - {r}_{s}^{2}}$$

ii—Calculation of P{Activity_{i,j}}

By definition, P{Activity_{i,j}} is the joint probability of two compatible events, i.e. the sensor modules of the nodes i and j are or become active when the target crosses their coverage zones. One therefore has:

P{Activity_{i,j}}=P{Activityᵢ}·P{Activityⱼ} (9)

By distinguishing the case when the node i is active upon the target entering its zone and the case when it becomes active during the crossing, we have, like for the calculation of P{Activityᵢ} for P_{d1} (see [Meda09]),:

P{Activityᵢ}=βₛₑₙₛ+(1−βₛₑₙₛ)P{ε_{det}| ε̅_{target},ε_{SoT}_{ᵢ}}. (10)

wherein P{ε_{det}| ε̅_{target}, ε_{SoT}_{ᵢ}} expresses the probability that the node i becomes active during the crossing of its zone by the target. In order to calculate this probability, the joint probability density is of the crossing time noted as T_{cross} and of the relative arrival time of the target after the beginning of the duty cycle, noted as Tₐ, is calculated. For each node, Tₐ is written as:

$$\begin{matrix}{f}_{Ta , Tcross} ( t , τ ) = {f}_{Ta} ( t ) {f}_{Tcross} ( τ ) \\ = \frac{1}{υ} {f}_{Ta} ( t ) {f}_{L} ( τ ) \\ = \frac{1}{c υ} {f}_{L} ( τ )\end{matrix}$$

since Tₐ is uniformly distributed over the interval[0,c] wherein c=(1−βₛₑₙₛ)Tₛₑₙₛ.

### Formulation of the Length of the Li ou Lj Chord.

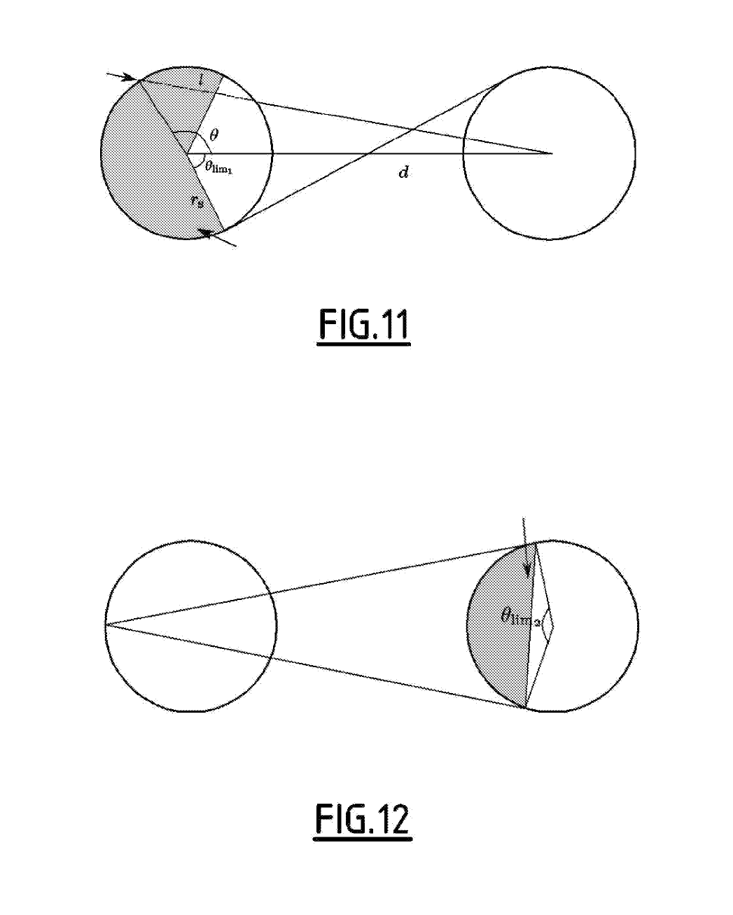

The considered trajectories cut both the ranges of i and of j. According to the diagrams of FIGS. 11 and 12, the angle for the possible entry points in the node i (orange zone) is of width [θₗᵢₘ_{₁}, 2π−θₗᵢₘ_{₁}].

On the basis of geometrical considerations, the length of the chord, noted as l, forming a particular realization of Lᵢ, depending on the entry angle θ, is obtained:

$$l = {b}_{1} - \sqrt{{r}_{s}^{2} + {d}^{2} - 2 {r}_{s} d [ - \sqrt{( 1 - \frac{d sin θ}{{b}_{1}} ) ( 1 - \frac{{r}_{s} sin θ}{{b}_{1}} )} + \frac{{r}_{s} d {sin}^{2} θ}{{b}_{1}^{2}} ]} \qquad ( 11 )$$

wherein b=\sqrt{rₛ²+d²−2rₛd cos θ} and wherein d is expressed as follows:

$$d = \{ \begin{matrix}{d}_{i , j} , & ( i ) \\ {d}_{i , j} + {r}_{s} & ( j )\end{matrix}$$

depending on whether node i or node j is considered.

As equation (11) is quite complex, l may approximately be fitted with a parabolic function: l=a₁θ²+a₂θ+a₃ with θ in [θₗᵢₘ_{₁}, 2π−θₗᵢₘ_{₁}] or node i, and [π−θₗᵢₘ_{₂}, π+θₗᵢₘ_{₂}] for node j. The coefficients a₁, a₂ and a₃ are obtained as in the table hereafter.

| | |
|---|---|
| a₁ | $- \frac{2 {r}_{s}}{{( π - {θ}_{lim} )}^{2}}$ |
| a₂ | −2a₁π |
| a₃ | a₁π² + 2rₛ |

By utilizing this approximation and by applying the same fundamental theorem as in [Meda09] (equations 6 and 7), and by performing the substitution Y=L/v we obtain:

$${f}_{i} ( {T}_{a} , Y ) = \frac{υ}{c \sqrt{16 {r}_{s}^{2} - 8 {r}_{s} υ Y}} if 0 < Y < \frac{2 {r}_{s}}{υ}$$

and otherwise 0.

wherein c=(1−βₛₑₙₛ)Tₛₑₙₛ.

Finally, by integrating over the whole of the realizations of Li (resp. Lj), it is shown that:

$$\begin{matrix}P \{ {ɛ}_{det} \vert {ɛ}_{target} \cdot {ɛ}_{{SoT}_{i}} \} = P \{ {ɛ}_{det} \vert {\overline{ɛ}}_{target} , {ɛ}_{{SoT}_{j}} \} \\ = \{ \begin{matrix}\frac{4 {r}_{s}}{3 c υ} & if 2 {r}_{s} / υ < c \\ \frac{\begin{matrix}\frac{4 {r}_{s}}{3} - \\ \frac{( c υ + 4 {r }_{s} ) \sqrt{\begin{matrix}16 {r}_{s}^{2} - \\ 8 c {r}_{s} υ\end{matrix}}}{12 {r}_{s}}\end{matrix}}{c υ} + & \frac{\sqrt{16 {r}_{s}^{2} - 8 {r}_{s} c υ} \text{?}}{4 {r}_{s}} \\ & otherwise .\end{matrix}\end{matrix} \\ \text{?} \text{indicates text missing or illegible when filed} \qquad ( 12 )$$

Thus, P_{{Activityi}}=P_{{Activityj}}, and finally P_{d2} is obtained by combining equations (8), (9), (10) and (12).

Delay for Transmitting the Alerts

We propose an analytical model for the alert transmission delay, i.e. the duration between the detection of the presence of an intruder by a sensor node and the notification of this detection to the gateway node. In the following, we calculate the delay at a radio hop, noted as D_{1 hop}, and then the delay over a multi-jump path.

In order to model the delay, we consider X-MAC, a low power and asynchronous MAC layer protocol used in the networks of sensors applying activation cycles for radio. X-MAC uses a mechanism for listening to a low power channel (Low Power Listening or LPL) in order to allow communication between a transmitter and a receiver which do not synchronize their waking and sleeping programs. Indeed, when a node wishes to send data, it transmits a preamble for a duration at least as long as the sleep interval of the receiving node. This guarantees that the receiver will awaken, detect the preamble and remain awake for receiving the data from the transmitter node. X-MAC uses a hashed preamble with which the sender rapidly alternates between the sending of the destination address of the data packet and a short waiting time. This allows the addressee to abort the process in order to receive the data.

The average transmission delay, at one jump, may be expressed as follows:

$${D}_{1 hop} = \frac{{( 1 - {β}_{comm} )}^{2} {T}_{comm}}{2} + {S}_{p} + {S}_{al} + {S}_{d}$$

wherein β_{comm} is the (normalized) proportion of the time during which the radio transmission module is active on the cycle of duration T_{comm}, and S_{P}, Sₐₗ, S_{d}, being the respective durations of the elementary preamble, of the receipt of acknowledgment of the preamble, and of the sending of the data packet relating to the detected intrusion. If the state of the addressed node is considered, i.e. the active or inactive state of its communication module, the probability that a node begins its transmission when the addressed node is active is β_{comm} and the associated delay is S_{P}+Sₐₗ+S_{d}. Conversely, the probability that a node is off is 1−β_{comm}. We evaluate D_{1 hop} by averaging between the least favorable case and the most favorable case in terms of delay. The most favorable case is the one when the node begins to transmit its preamble exactly from the moment when the addressed node awakes from its sleeping cycle. In that case, the packet is transmitted after the duration Sₚ+Sₐₗ+S_{d}. In the least favorable case, the transmitter node waits for the whole sleeping duration of the addressed node. Further, as the addressed node should receive an entire elementary preamble before acknowledging the sending of the packet, the delay takes into account that two transmissions of the elementary preamble may be necessary before beginning the exchange of data. In this case, the transmission delay at one jump is (1−β_{comm}) T_{comm}+(Sₚ+Sₐₗ)+S_{d}. The equation (1) above is obtained by weighting in each equation the term related to the waiting before sending the preamble with the probability that the addressee is in the active or inactive state, and (2) by averaging the least and most favorable cases.

Energy Consumption Model

Given that the nodes operate on a battery, how they consume energy has a direct influence on the lifetime of the monitoring system. In order to take this into account, we propose here a simple energy model for the energy consumption at the scale of the network of sensors.

The energy consumption of the nodes may be given by the sum of the energies consumed by its hardware components. For the sake of simplicity, we only integrate into the energy model the contributions of the detection module and of the radio transceiver. We also define the lifetime of the network as the time required for having the residual average energy Eᵣ pass under a threshold value Eₜₕ.

In order to obtain an expression of the lifetime of the network, we evaluate the energy consumed after a given time interval t. Eᵣ, the average residual energy at instant t, may be expressed as follows:

Eᵣ(t)=NEᵢ−NΩₜₒₜt

wherein Ei is the initial energy of a node and Ωₜₒₜ is the power required by the operation of the detection and communication modules.

According to the description of the X-MAC protocol, the communication module may be in one of the four following states: (i) transmission, (ii) reception, (iii) sleeping and (iv) LPL. The respective power budgets are noted as Ω_{R}, Ω_{T}, Ωₛ and Ω_{LPL}.

Ωₜₒₜ may then be calculated as follows:

Ωₜₒₜ=Ωₛ+Ω_{LPL}+(Ω_{R}+Ω_{T})P_{d}N_{target}

wherein Ω_{R}, Ω_{T}, Ωₛ and Ω_{LPL} are the powers described earlier; P_{d} is the target detection probability, and N_{target} is the number of times a target appears during a reference period.

The remainder of the calculation appears in [Meda09].

The application of the global method for assisting with the deployment of a UGS network is detailed hereafter. Two types of scenarios are contemplated:
A “single zone” scenario: in this case, the monitored space is for example a single zone, i.e a square zone at the centre of which is located the camp or bivouac to be protected.
A “multiple zone” scenario: in this case, the monitored space for example consists of multiple zones around or surrounding the camp. These zones may be of different shapes (for example disks, potato shapes). The operator will for example try to monitor a set of zones poorly covered by an optronic or radar system.

“Single Zone” Scenario

In this case, it is for example conceivable that the operator has 20 nodes to be deployed for monitoring a square surface with a side of 1,000 meters. The performance constraints that the monitoring system has to meet, are a delay D of less than 100 ms on the one hand, and a miss-detection probability, P_{md}, of less than 10% on the other hand. Finally the presence of large passage points imposes that the operator places a sensor at each of the corners of the zone.

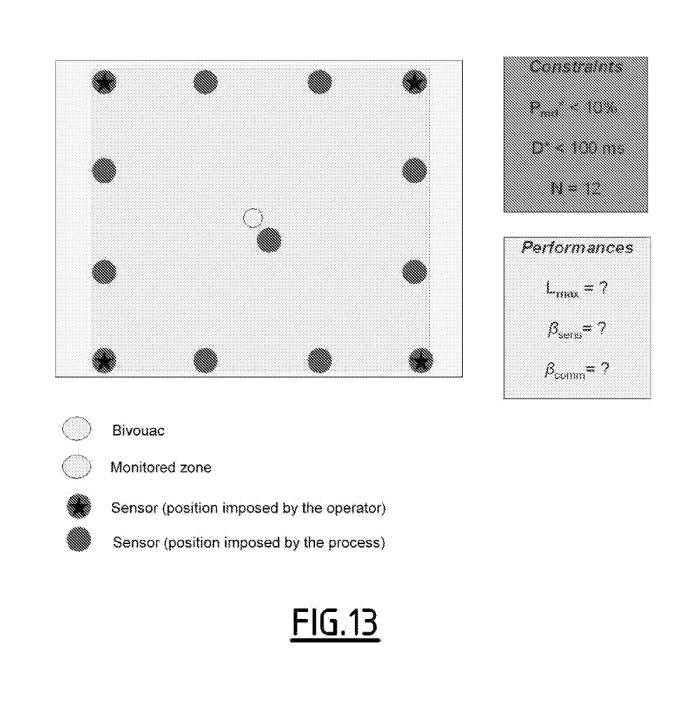

By initializing the method described in the document, with 13 nodes made available in a first phase (N₀=4, Nₛᵤₚₚ=9), the method will thus suggest to the operator the positioning of the nodes as indicated in FIG. 13. During its operation, the process PROC will describe the space of solutions observing the <<threshold>> values of the constraints.

Considering the space of solutions, the best of the optimum values of the lifetime is about 25 days, with as performances P_{md}=10% and D=100 ms. The method informs the operator about this optimum operating point, as well as about the associated system configuration.

With MODE2 and an objective for example set to 20 days, the process would have reiterated with a smaller number of nodes to be deployed. On the contrary, with an objective for example set to 30 days, the process would have reiterated with a larger number of nodes to be deployed.

“Multiple-Zones” Scenario

This scenario envisions the deployment of a UGS network over a set of zones, knowing that there exist different constraints for each of the zones. The motivation for such a deployment may be:
Extending the coverage of the monitoring zone around the camp with placement of a second glacis characterized by less strict constraints in terms of detection reliability and delay
Ensuring monitoring of sensitive zones away from the camp (for example a zone 1 around a pass, a zone 2 around a water supply point, a zone 3 around a fuel supply centre)
Filling the various non-covered zones with a long range observation system (camera, radar, for example).

Let us take the example of the extension of the monitoring zone around the camp.
At most 15 nodes to be placed.
In the zone 1 surrounding the camp within a radius of 100 m:
   Pmd₁<5%
   D₁<100 ms
   Initiate the optimization process on zone 1 with 5 nodes
   Use at most 10 nodes
   Objective No. 1:
How many nodes do I need for meeting the constraints?
With which positioning and configuration is it possible to attain the lifetime L₁ equal to 50 days?
   Apply PROC_{Z1} in MODE2
PROC_{Z1}(CPC*⁽¹⁾, CPO_{obj}⁽¹⁾, Nₛᵤₚₚ⁽¹⁾, Nₘₐₓ⁽¹⁾, d⁽¹⁾)=(POS_{N}⁽¹⁾, PFₒₚₜ⁽¹⁾, N_{req}⁽¹⁾, CONF⁽¹⁾, MS⁽¹⁾)

with CPC*⁽¹⁾={Pmd₁<5%, D₁<100 ms}, CPO_{obj}⁽¹⁾=50 days Nₛᵤₚₚ⁽¹⁾=5, Nₘₐₓ⁽¹⁾=10, d⁽¹⁾=100 m
In the zone 2 extending beyond the zone 1, knowing the number of remaining nodes:
   Pmd₂<30%
   D₂<500 ms
   Objective No. 2
What is the maximum surface area of zone 2 for meeting the constraints?
What are the positioning and configuration which then maximize the lifetime L₂?
   Apply PROC_MAX-SURFACE_{Z2}
PROC_MAX-SURFACE_{Z2}(CPC*⁽²⁾,Nₛᵤₚₚ⁽²⁾)=(POS_{N}⁽²⁾, PFₒₚₜ⁽²⁾, CONF⁽²⁾, MS⁽²⁾)

with CPC*⁽²⁾={Pmd₂<30%, D₂<500 ms}, Nₛᵤₚₚ⁽²⁾=5

After a 1^{st} iteration of the global method consisting of successively applying PROC_{Z1} and then PROC_MAX-SURFACE_{Z2}, the operator for example obtains the following results:
In zone 1, there exists an optimum configuration of the system meeting the constraints and with which a lifetime of the system may be obtained equal to 50.5 days. At least 8 nodes have to be deposited in order to attain this lifetime. The method shows the optimum operating point and the corresponding configuration.
In zone 2, by using 5 nodes, the maximum size of the zone for observance of the constraints is 817 m. The method shows the optimum operating point and the corresponding configuration.

Considering these results, either the operator is satisfied with the suggested deployment and configuration, or else he/she for example chooses to reiterate the procedure by reallocating the 2 nodes still available to him/her, to zone 2 in order to at most extend the coverage of the latter. After a second iteration of the global method, it obtains different results in the 2^{nd} zone. For example the maximum size is then 1,289 m. The method shows the optimum operating point and the corresponding configuration.

FIG. 1 shows an example for distributing and positioning the nodes, provided at the end of the global method over the 2 zones for the inputs defined earlier.

The advantages of this method are:
Its capability of integrating and calculating the exact positions of the sensors
The possibility for the operating procedure of operating iteratively
Its capability of connecting all the components of the system with each other
Assisting the operating procedure managing the deployment in order to make the best possible decisions as to the parameterization of the system
Its extensibility insofar that the models may be changed or extended.

1. A method for configuring a wireless network of Unattended Ground Sensors (UGS), comprising interconnected nodes each including a sensing module, a power supply, a processor, a communication device, an operating configuration storage and an operation configuration manager to manage according to this configuration stored in memory, comprising the following steps:
defining performance criteria forming constraints, with associated threshold values, and at least one performance criterion to be optimized, for at least one zone to be equipped with nodes, each performance criterion being defined by a model;
defining for said or each zone: characteristics (d) of the zone; and
characteristics of the sensors in the zone;
allocating to said zone to be equipped, a number of nodes; applying an optimization process on said zone, the optimization process per zone comprising the following steps:
determining the position of the nodes in the zone if it exists for meeting a predetermined optimization criterion;
determining an operating point if it exists, characterizing the behavior of the network of sensors in the zone;
determining the configuration of the network of sensors in the zone if it exists, defining the configuration parameters of the network of sensors; and
determining the possible need of using more nodes or revising the performance criteria defined;
increasing the number of nodes or modifying the performance criteria defined in said zone where the performance criteria are not met and reproducing in these zones the optimization process per zone with the new number of nodes or the new performance criteria, and
applying the configuration determined at each node in said or each zone.

2. The method according to claim 1, wherein the step for defining the performance criteria to be optimized comprises the step of attaining the definition of a threshold value for at least one performance criterion to be optimized, and the optimization process per zone includes a step of incrementing the number of nodes for equipping the zone, if at least one performance criterion to be optimized is not met in order to determine the minimum number of nodes required for meeting the performance criteria and a reproduction of the first three applying steps with the incremented new number of nodes.

3. The method according to claim 1, wherein the step for defining the performance criteria to be optimized comprises the step of attaining the definition of a threshold value for at least one performance criterion to be optimized, and in that the optimization process per zone includes a step for decrementing the number of nodes for equipping the zone, if all the performance criteria to be optimized are met in order to determine the minimum number of nodes required for meeting the performance criteria and a reproduction of the first three applying steps with the decremented new number of nodes.

4. The method according to claim 1, wherein the step for defining the characteristics of the zone comprises the step of defining a minimum value for the dimension of the zone, and in that the optimization process per zone includes successive steps for incrementing the dimension of the zone and for reproducing the first three applying steps with the new dimension of the zone, until there exists no operating point meeting the performance criteria forming constraints.

5. The method according to claim 1, wherein in that the predetermined optimization criterion, for determining the position of the nodes is to minimize a non-detection probability (P_{md}) by the network under the assumption of permanent activation of the sensor of each node.

6. The method according to claim 9, wherein step for allocating the nodes comprises in at least one zone, the setting of imposed positions (POS_{NO}) for at least one node in the zone and the step for determining the position of the nodes takes into account the positions imposed for at least said node.

7. The method according to claim 1, wherein it includes analytical modeling of the non-detection probability of a target applying the known positions of the sensors (calculation of Pmd).

8. A device including the method according to claim 1.

9. A computer program including specific instructions for applying the method according to claim 1, when applied on a computer.
